(19) United States
(12) Patent Application Publication
(10) Pub. No.: US 2012/0176771 A1
(43) Pub. Date: Jul. 12, 2012

(54) Backlight Device for Liquid Crystal Display

(76) Inventor: Syue-Min Li, Taipei City (TW)

(21) Appl. No.: 13/346,871

(22) Filed: Jan. 10, 2012

(30) Foreign Application Priority Data
Jan. 12, 2011 (TW) 100101054

(51) Int. Cl. G09F 13/04; F21V 9/00

(52) U.S. Cl. 362/97.1

(57) ABSTRACT

A backlight device includes a mounting substrate having circuit traces laid out in a predetermined pattern on a mounting surface thereof. A plurality of light-emitting elements are connected electrically to the circuit traces. A diffusion film assembly includes a first diffusion film disposed above the light-emitting elements, and a second diffusion film disposed between the first diffusion film and the light-emitting elements and having a plurality of protrusions each projecting toward a respective light-emitting element. The first diffusion film reflects twice the light that passes through the second diffusion film and balances once again the light, so that the light transmits uniformly to a thin film transistor glass.

### CROSS REFERENCE TO RELATED APPLICATION

This application claims priority of Taiwanese Patent Application No. 100101054, filed on Jan. 12, 2011.

### BACKGROUND OF THE INVENTION

1. Field of the Invention

The invention relates to a backlight device for a liquid crystal display (LCD), and more particularly to a backlight device for an LCD TV.

2. Description of the Related Art

With the demand for development of thin and light electronic products, a light source of the backlight device for an LCD display is gradually replaced from the conventional CCFL to LED.

Currently, a conventional backlight device with LED as light source is a side-edge type, that is, backlight bars installed with LED are disposed on one of the left and right sides or both and/or one of the top and bottom sides or both. However, since the size of the LCD TV is getting bigger and bigger, the side-edge type backlight device will encounter the problem of distributing uniform light to the whole screen. Hence, a direct type backlight device is developed to resolve the aforesaid problem of the side-edge type backlight device.

### SUMMARY OF THE INVENTION

Therefore, an object of this invention is to provide an improvement to a backlight device for a liquid crystal display (LCD).

According to one aspect of this invention, a backlight device comprises a mounting substrate, a plurality of light-emitting elements, and a diffusion film assembly. The mounting substrate has a mounting surface, and circuit traces laid out in a predetermined pattern on the mounting surface. The light-emitting elements are mounted in an array on the mounting surface, and are connected electrically to the circuit traces. The diffusion film assembly includes a first diffusion film disposed above the light-emitting elements, and a second diffusion film disposed between the first diffusion film and the light-emitting elements. The second diffusion film has a plurality of protrusions each projecting toward a respective light-emitting element for diffusion of light. The first diffusion film reflects twice the light that passes through the second diffusion film and balances once again the light, so that the light transmits uniformly to a thin film transistor (TFT) glass.

According to another aspect of this invention, a backlight device comprises a diffusion film assembly including a first diffusion film and a second diffusion film opposite to the first diffusion film, and at least one light source unit disposed between the first and second diffusion films and including a transparent tubular housing, a transparent carrier plate disposed in the transparent tubular housing and parallel to the first and second diffusion films, and a plurality of light source modules disposed on the transparent carrier plate. Each light source module includes a mounting substrate disposed on the transparent carrier plate, and a plurality of light-emitting elements mounted on the mounting substrate.

According to still another aspect of this invention, a backlight device comprises a light source unit and a diffusion film assembly. The light source unit includes a mounting substrate and a plurality of light-emitting elements. The mounting substrate has amounting surface laid out with a predetermined pattern of circuit traces, and a plurality of indentations formed in an array on the mounting surface. Each light-emitting element is disposed on a bottom portion of a respective indentation. The diffusion film assembly is disposed above the light source unit, and includes a first diffusion film, and a second diffusion film disposed between the first diffusion film and the light source unit and having a plurality of semi-transparent or non-transparent reflective metal layers provided on a surface of the second diffusion film that faces the mounting surface. Each reflective metal layer corresponds in position to a respective one of the light-emitting elements.

According to yet another aspect of this invention, a backlight device comprises a light source unit and a diffusion film assembly. The light source unit includes a mounting substrate and a plurality of light-emitting elements mounted in an array on the mounting surface. The diffusion film assembly includes first and second diffusion films. The first diffusion film is disposed above the mounting substrate and is formed with a plurality of through holes so that the first diffusion film has a light grating effect. The second diffusion film is disposed above the first diffusion film. The light grating effect of the first diffusion film creates light interferences when the light from the light-emitting elements is incident on the first diffusion film. The through holes of the first diffusion film produce different peaks and valleys by light interferences, which are thereafter mixed and projected onto the second diffusion film to achieve uniform brightness.

According to still yet another aspect of this invention, a backlight device comprises a diffusion film and a light source unit including a mounting substrate and a plurality of light-emitting elements. The mounting substrate is disposed below the diffusion film, and has a mounting surface facing the diffusion film and laid out with a predetermined pattern of circuit traces, and a plurality of indentations formed on the mounting surface. Each indentation has a surface that is treated to achieve a reflection effect. Each light-emitting element is mounted on a bottom portion of a respective indentation, and has a top surface provided with a triangular lens so that light emitted from each light-emitting element can be transmitted upward and sideward. Light emitted from the sideward is reflected from the surface of the respective indentation toward the diffusion film to achieve uniform brightness.

According to still further aspect of this invention, a backlight device comprises a diffusion film, and a light source unit including a mounting substrate and a plurality of sets of light-emitting elements. The mounting substrate is disposed be low the diffusion film, and has a mounting surface facing the diffusion film and laid out with a predetermined pattern of circuit traces. Each set of the light-emitting elements has first to fourth light-emitting elements mounted on the mounting surface of the mounting substrate and connected electrically to the circuit traces. The first to fourth light-emitting elements emit different colors of light.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded schematic side view of a backlight device according to the first preferred embodiment of this invention;

FIG. 2 is a fragmentary schematic top view of the first preferred embodiment;

FIG. 3 is a fragmentary sectional view of a backlight device according to the second preferred embodiment of this invention;

FIG. 4 is a fragmentary schematic top view of the second preferred embodiment;

FIG. 5 is a fragmentary exploded schematic side view of a backlight device according to the third preferred embodiment of this invention;

FIG. 6 is a fragmentary schematic top view of the third preferred embodiment;

FIG. 7 is a fragmentary exploded schematic side view of a backlight device according to the fourth preferred embodiment of this invention;

FIG. 8 is a fragmentary schematic top view of the fourth preferred embodiment;

FIG. 9 is a fragmentary exploded schematic side view of a backlight device according to the fifth preferred embodiment of this invention; and

FIG. 10 is a fragmentary exploded schematic side view of a backlight device according to the sixth preferred embodiment of this invention.

### DETAILED DESCRIPTION OF THE PREFERRED EMBODIMENTS

Before this invention is described in detail, it should be noted that, in the following description, similar elements are designated by the same reference numerals. The enclosed drawings are used for reference and description only, and are not used for limiting the present invention.

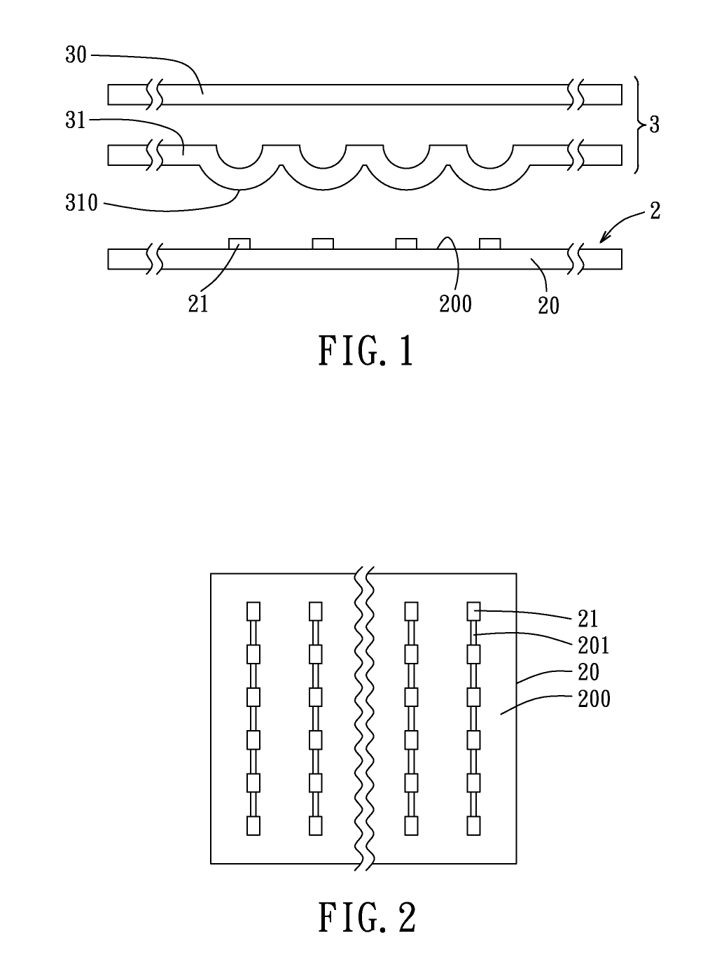

Referring to FIGS. 1 and 2, a backlight device according to the first preferred embodiment of this invention is shown to comprise a light source unit 2 and a diffusion film assembly 3 disposed above the light source unit 2.

The light source unit 2 includes a mounting substrate 20 and a plurality of light-emitting elements 21. The mounting substrate 20 has a mounting surface 200 laid out with a predetermined pattern of circuit traces 201 (see FIG. 2). The light-emitting elements 21 are mounted in an array on the mounting surface 200, and are connected electrically to the circuit traces 201. The light-emitting elements 21 can be mounted on the mounting substrate 20 by using any suitable technique, such as surface mount device (SMD), chip on board (COB), flip-chip, etc. Each of the light-emitting elements 21 produces a white light formed bypassing blue light through the phosphor powder or formed by a mixture of light from red-green-blue (RGB) chips. It should be noted that the CRI (Color Rendering Index) of the white light-emitting elements 21 produced from any method is above 70 and conforms to the requirement of the TV backlight device.

The diffusion film assembly 3 includes a first diffusion film 30 disposed above the light-emitting elements 21, and a second diffusion film 31 disposed between the first diffusion film 30 and the light-emitting elements 21. In this embodiment, the second diffusion film 31 is formed with a plurality of protrusions 310. Each of the protrusions 310 corresponds in position to and projects toward a respective one of the light-emitting elements 21. Each protrusion 310 is configured as a concave lens to effect diffusion of light. It should be noted that a surface of each protrusion 310 that faces the respective light-emitting element 21 can be selectively coated with a total or half reflection layer (not shown) to achieve twice reflection of light.

The first diffusion film 30 reflects twice the light that passes through the second diffusion film 31 and balances once again the light, so that the light transmits uniformly to a thin film transistor (TFT) glass (not shown) to thereby achieve the purpose of backlighting.

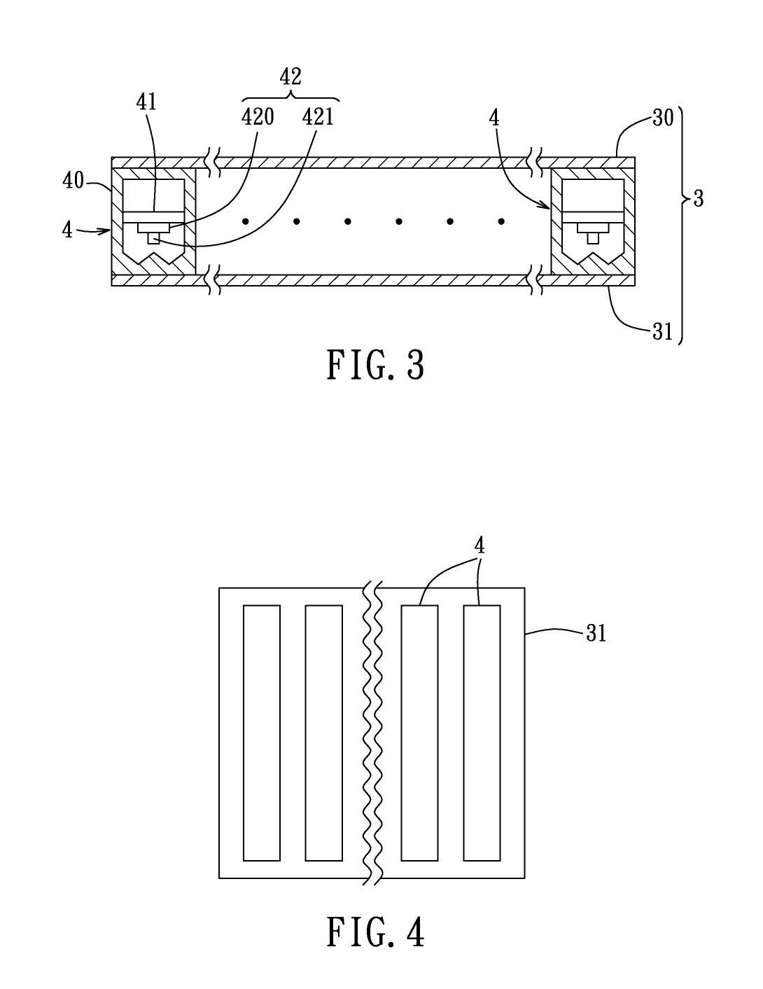

Referring to FIGS. 3 and 4, a backlight device according to the second preferred embodiment of this invention comprises a diffusion film assembly 3 and a plurality of light source units 4.

The diffusion film assembly 3 includes a first diffusion film 30 and a second diffusion film 31 opposite to and spaced apart from the first diffusion film 31.

The light source units 4 are disposed between the first and second diffusion films 30, 31. Each of the light source units 4 includes a transparent tubular housing 40, a transparent carrier plate 41 disposed in the tubular housing 40 and parallel to the first and second diffusion films 30, 31, and a plurality of light source modules 42 disposed on the carrier plate 41.

The transparent tubular housing 40 can be made from any suitable material, and can have any suitable outer shape, for example, a cylindrical shape, a square shape, a triangular shape, etc. As long as the inner surface thereof that faces the light source modules 42 is coated with a light reflection layer and is formed with a V-shaped, W-shaped or U-shaped cross section to achieve light reflection, any outer shape of the transparent tubular housing 40 is acceptable.

Each of the light source modules 42 includes a mounting substrate 420 disposed on the carrier plate 41, and a plurality of light-emitting elements 421 mounted on the mounting substrate 420. The mounting substrate 420 is made of a material selected from a group consisting of metals and non-metals.

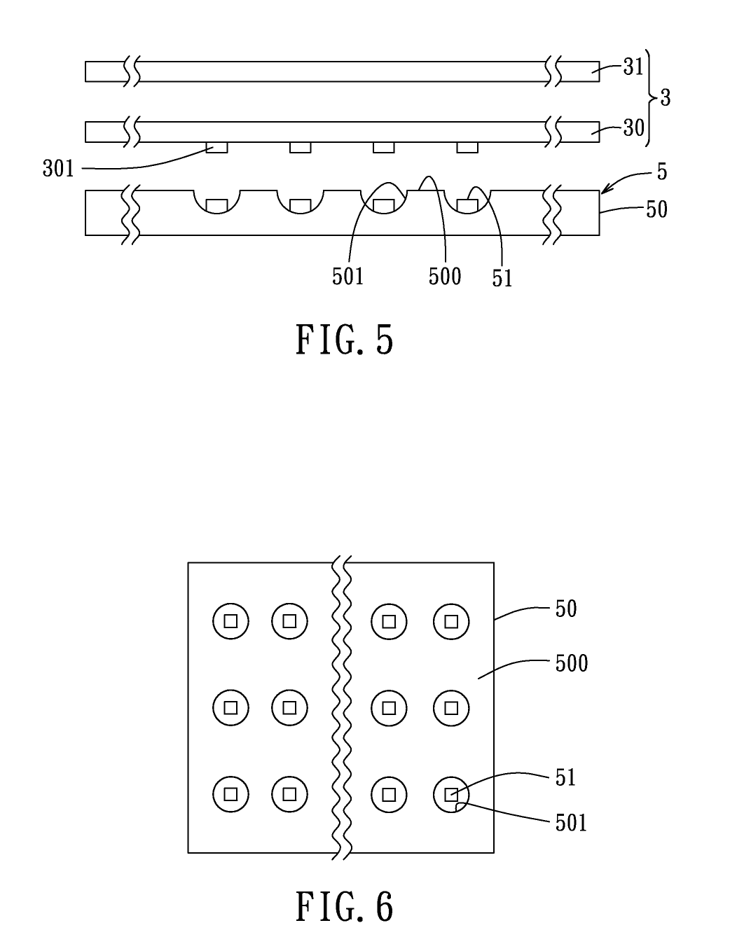

Referring to FIGS. 5 and 6, a backlight device according to the third preferred embodiment of this invention comprises a diffusion film assembly 3 and a light source unit 5.

The light source unit 5 includes amounting substrate 50 and a plurality of light-emitting elements 51. The mounting substrate 50 has a mounting surface 500 laid out with a predetermined pattern of circuit traces (not shown), and a plurality of indentations 501 formed in an array on the mounting surface 500. Each of the indentations 501 has a surface that is treated to achieve a reflection effect.

Each of the light-emitting elements 51 is mounted on a bottom portion of a respective one of the indentations 501. Similar to that described in the first preferred embodiment, the light-emitting elements 51 can be mounted on the mounting substrate 50 by using any suitable technique, such as SMD, COB, flip-chip, etc. Further, each light-emitting element 51 produces a white light formed by passing blue light through the phosphor powder or formed by a mixture of light from a plurality of RGB chips.

The diffusion film assembly 3 includes a first diffusion film 30 and a second diffusion film 31. The first diffusion film 30 is disposed between the mounting substrate 50 and the second diffusion film 31. The first diffusion film 30 has a plurality of semi-transparent or non-transparent reflective metal layers 301 provided on a surface thereof that faces the mounting substrate 50. Each of the reflective metal layers 301 corresponds in position to a respective one of the light-emitting elements 51.

Through the aforesaid structure, light emitted from a surrounding side of each light-emitting element 51 is reflected by the surface of the respective indentation 501 toward the first diffusion film 30, and light emitted from a top surface of each light-emitting element 51 is reflected by the respective reflective metal layer 301 to the respective indentation 501, and then from the indentation 501, light is reflected toward the first diffusion film 30. Light emits toward the second diffusion film 31 after being evenly diffused in the first diffusion film 30.

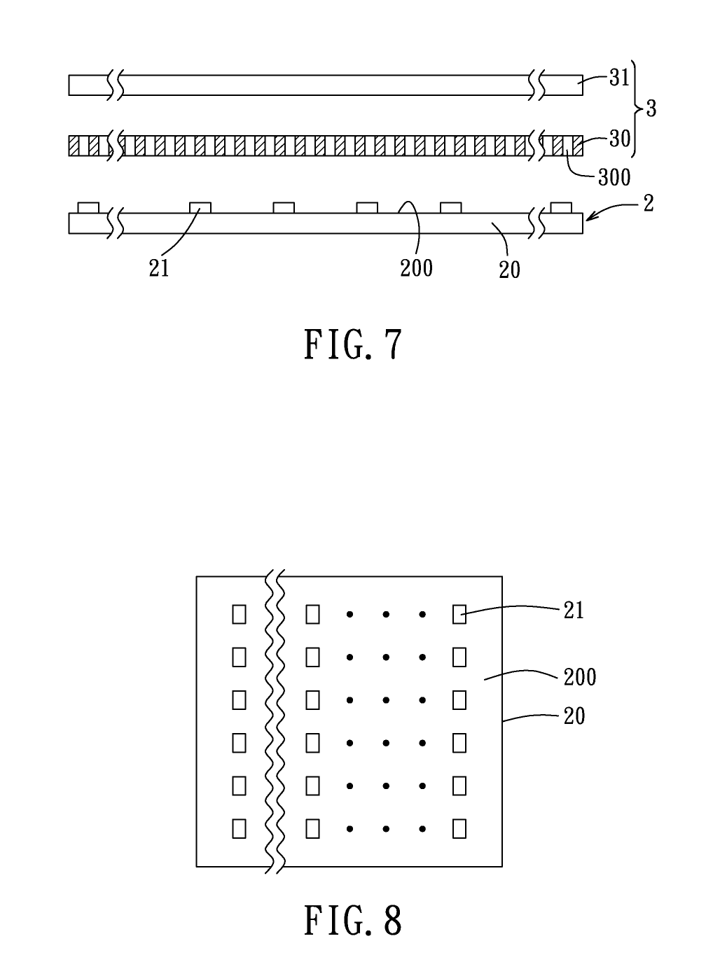

Referring to FIGS. 7 and 8, a backlight device according to the fourth preferred embodiment of this invention is shown to comprise a light source unit 2 and a diffusion film assembly 3.

The light source unit 2 includes amounting substrate 20, and a plurality of light-emitting elements 21 mounted in an array on the mounting surface 200.

The diffusion film assembly 3 includes a first diffusion film 30 and a second diffusion film 31. The first diffusion film 30 is disposed above the mounting substrate 20, and is formed with a plurality of through holes 300 so that the first diffusion film 30 has a light grating effect. The second diffusion film 31 is disposed above the first diffusion film 30 such that the first diffusion film 30 is disposed between the second diffusion film 31 and the mounting substrate 20.

From the aforesaid structure, the light grating effect of the first diffusion film 30 creates light interferences when the light emitted from the light-emitting elements 21 is incident on the first diffusion film 30. The through holes 300 of the first diffusion film 30 produces different peaks and valleys by light interferences, which are thereafter mixed and projected onto the second diffusion film 31 to achieve uniform brightness.

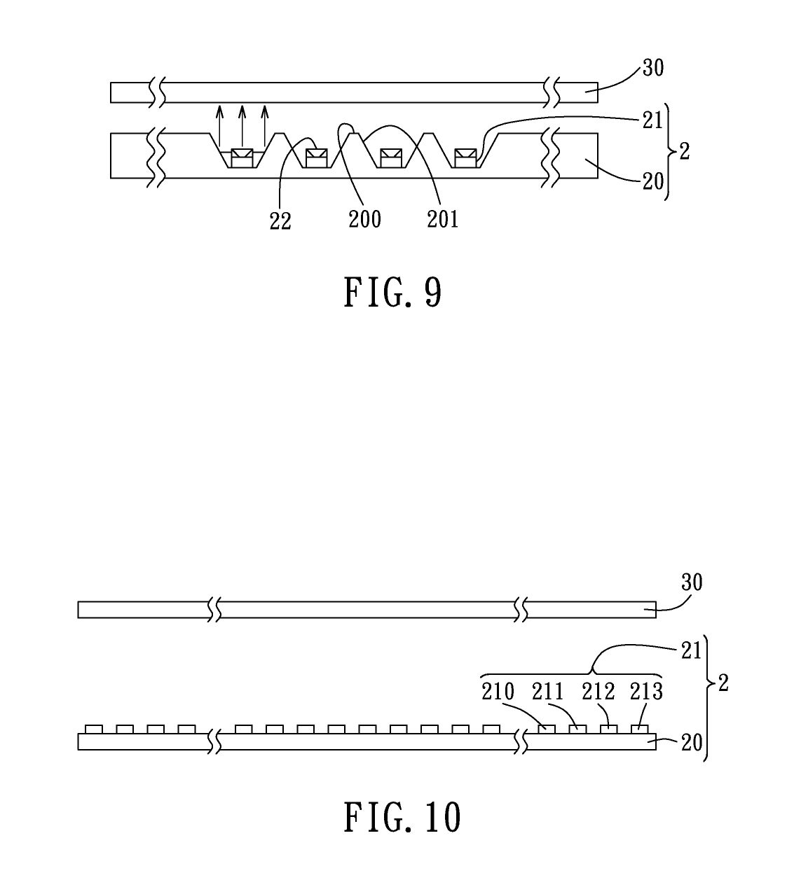

Referring to FIG. 9, a backlight device according to the fifth preferred embodiment of this invention is shown to comprise a diffusion film 30 and a light source unit 2.

The light source unit 2 includes a mounting substrate 20 and a plurality of light-emitting elements 21. The mounting substrate 20 has a mounting surface 200 disposed below the diffusion film 30 and laid out with a predetermined pattern of circuit traces (not shown), and a plurality of indentations 201 formed in an array on the mounting surface 200. Each indentation 201 has a surface that is treated to achieve a reflection effect.

Each of the light-emitting elements 21 is mounted on a bottom portion of a respective one of the indentations 201, and has a top surface provided with a triangular lens reflector 22 so that light emitted from each light-emitting element 21 can be transmitted upward and sideward. Light emitted from the sideward is reflected from the surface of the respective indentation 201 toward the diffusion film 30 to achieve uniform brightness.

Referring to FIG. 10, a backlight device according to the sixth preferred embodiment of this invention is shown to comprise a diffusion film 30 and a light source unit 2.

The light source unit 2 includes amounting substrate 20 and a plurality of sets of light-emitting elements 21. The mounting substrate 20 is disposed below the diffusion film 30, and has a mounting surface 200 facing the diffusion film 30 and laid out with a predetermined pattern of circuit traces (not shown).

Each set of the light-emitting elements 21 includes a first light-emitting element 210 for emitting red light, a second light-emitting element 211 for emitting green light, a third light-emitting element 212 for emitting blue light, and a fourth light-emitting element 213 for emitting yellow light. The first to fourth light-emitting elements 210, 211, 212, 213 are mounted on the mounting surface 200 and are connected electrically to the circuit traces. When the light-emitting elements 210, 211, 212, 213 are activated, the red, green, blue and yellow lights are mixed to form a white light having a CRI value of above 100. Further, by controlling the integrated circuit of the light-emitting elements 210, 211, 212, 213, more than two million different colors may be obtained.

Hence, the object of the present invention can be realized.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A backlight device comprising:
a mounting substrate having a mounting surface, and circuit traces laid out in a predetermined pattern on said mounting surface;
a plurality of light-emitting elements mounted in an array on said mounting surface and connected electrically to said circuit traces; and
a diffusion film assembly including a first diffusion film disposed above said light-emitting elements, and a second diffusion film disposed between said first diffusion film and said light-emitting elements, said second diffusion film having a plurality of protrusions each projecting toward a respective one of said light-emitting elements for diffusion of light;
said first diffusion film reflecting twice the light that passes through said second diffusion film and balances once again the light, so that the light transmits uniformly to a thin film transistor (TFT) glass.

2. The backlight device as claimed in claim 1, wherein said light-emitting elements are mounted on said mounting substrate by using one of surface mount device (SMD), chip on board (COB), and flip-chip techniques.

3. The backlight device as claimed in claim 1, wherein each of said protrusions is selectively coated with a total or half reflection layer on a surface thereof that faces the respective one of said light-emitting elements to achieve twice reflection of light.

4. The backlight device as claimed in claim 1, wherein each of said light-emitting elements produces a white light formed by passing blue light through phosphor powder or formed by a mixture of light from red-green-blue (RGB) chips.

5. A backlight device comprising:
a diffusion film assembly including a first diffusion film and a second diffusion film opposite to said first diffusion film; and
at least one light source unit disposed between said first and second diffusion films and including a transparent tubular housing, a transparent carrier plate disposed in said transparent tubular housing and parallel to said first and second diffusion films, and a plurality of light source modules disposed on said transparent carrier plate, each of said light source modules including a mounting substrate disposed on said transparent carrier plate, and a plurality of light-emitting elements mounted on said mounting substrate.

6. The backlight device as claimed in claim 1, wherein said light-emitting elements are mounted on said mounting substrate by using one of surface mount device (SMD), chip on board (COB), and flip-chip techniques.

7. The backlight device as claimed in claim 5, wherein said transparent tubular housing has an inner surface that faces said light source unit, said inner surface of said transparent tubular housing being coated with a light reflection layer and being formed with a V-shaped, W-shaped or U-shaped cross section.

8. The backlight device as claimed in claim 5, wherein said mounting substrate of each of said light source modules is made of a material selected from a group consisting of metals and non-metals.

9. The backlight device as claimed in claim 5, wherein each of said light-emitting elements produces a white light formed by passing blue light through phosphor powder or formed by a mixture of light from red-green-blue (RGB) chips.

10. A backlight device comprising:
a light source unit including a mounting substrate and a plurality of light-emitting elements, said mounting substrate having a mounting surface laid out with a predetermined pattern of circuit traces, and a plurality of indentations formed in an array on said mounting surface, each of said light-emitting elements being disposed on a bottom portion of a respective one of said indentations; and
a diffusion film assembly disposed above said light source unit, and including a first diffusion film and a second diffusion film disposed between said first diffusion film and said light source unit, said second diffusion film having a plurality of semi-transparent or non-transparent reflective metal layers provided on a surface of said second diffusion film that faces said mounting surface, each of said reflective metal layers corresponding in position to a respective one of said light-emitting elements.

11. The backlight device as claimed in claim 10, wherein said light-emitting elements are mounted on said mounting substrate by using one of surface mount device (SMD), chip on board (COB), and flip-chip techniques.

12. The backlight device as claimed in claim 10, wherein each of said indentations has a surface that is treated to achieve a reflection effect.

13. The backlight device as claimed in claim 10, wherein each of said light-emitting elements produces a white light formed by passing blue light through phosphor powder or formed by a mixture of light from red-green-blue (RGB) chips.

14. A backlight device comprising:
a light source unit including a mounting substrate and a plurality of light-emitting elements mounted in an array on said mounting surface; and
a diffusion film assembly including a first diffusion film and a second diffusion film, said first diffusion film being disposed above said mounting substrate and being formed with a plurality of through holes so that said first diffusion film has a light grating effect, said second diffusion film being disposed above said first diffusion film;
wherein the light grating effect of said first diffusion film creates light interferences when the light from said light-emitting elements is incident on said first diffusion film, said through holes of said first diffusion film producing different peaks and valleys by light interferences, which are thereafter mixed and projected onto said second diffusion film to achieve uniform brightness.

15. The backlight device as claimed in claim 14, wherein said light-emitting elements are mounted on said mounting substrate by using one of surface mount device (SMD), chip on board (COB), and flip-chip techniques.

16. The backlight device as claimed in claim 14, wherein each of said light-emitting elements produces a white light formed by passing blue light through phosphor powder, or formed by a mixture of light from red-green-blue (RGB) chips.

17. A backlight device comprising:
a diffusion film; and
a light source unit including a mounting substrate and a plurality of light-emitting elements, said mounting substrate being disposed below said diffusion film and having a mounting surface facing said diffusion film and laid out with a predetermined pattern of circuit traces, and a plurality of indentations formed on said mounting surface, each of said indentations having a surface that is treated to achieve a reflection effect, each of said light-emitting elements being mounted on a bottom portion of a respective one of said indentations and having a top surface provided with a triangular lens so that light emitted from each of said light-emitting elements can be transmitted upward and sideward, light emitted from said sideward being reflected from said surface of the respective one of said indentations toward said diffusion film to achieve uniform brightness.

18. The backlight device as claimed in claim 17, wherein said light-emitting elements are mounted on said mounting substrate by using one of surface mount device (SMD), chip on board (COB), and flip-chip techniques.

19. The backlight device as claimed in claim 17, wherein each of said light-emitting elements produces a white light formed by passing blue light through phosphor powder or formed by a mixture of light from red-green-blue (RGB) chips.

20. A backlight device comprising:
a diffusion film; and
a light source unit including a mounting substrate and a plurality of sets of light-emitting elements, said mounting substrate being disposed below said diffusion film and having amounting surface facing said diffusion film and laid out with a predetermined pattern of circuit traces, each set of said light-emitting elements having first to fourth light-emitting elements mounted on said mounting surface of said mounting substrate and connected electrically to said circuit traces, said first to fourth light-emitting elements emitting different colors of light.

21. The backlight device as claimed in claim 20, wherein said light-emitting elements are mounted on said mounting substrate by using one of surface mount device (SMD), chip on board (COB), and flip-chip techniques.
